(19) United States
(12) Patent Application Publication
(10) Pub. No.: US 2007/0185006 A1
(43) Pub. Date: Aug. 9, 2007

(54) Shamrock surfactants and their methods of use

(75) Inventor: David A. Jaeger, Laramie, WY (US)

Correspondence Address: DANN, DORFMAN, HERRELL & SKILLMAN, 1601 MARKET STREET, SUITE 2400, PHILADELPHIA, PA, 19103-2307, US

(73) Assignee: UNIVERSITY OF WYOMING, Laramie, WY (US)

(21) Appl. No.: 10/567,814

(22) PCT Filed: Sep. 22, 2003
(86) PCT No.: PCT/US03/29742

§ 371 Date: Aug. 14, 2006

Related U.S. Application Data
(60) Provisional application No. 60/495,214, filed on Aug. 13, 2003.

(51) Int. Cl. C11D 3/02

(52) U.S. Cl. 510/510

(57) ABSTRACT

Disclosed are surfactants that contain two ionic or polar nonionic head groups, each connected to a central ionic head group by a hydrocarbon linking moiety. The central head group is a dithiophosphate, dithiocarbamate, or quaternary ammonium group. These surfactants have potential applications in chemical decontamination of mustard (simulants), storage and release devices/chemical switches and the remediation of heavy-metal ion-contaminated water.

This application claims priority under 35 U.S.C. §119(e) to U.S. Provisional Application No. 60/495,214, filed on Aug. 13, 2003, the entire contents of which are incorporated by reference herein.

Pursuant to 35 U.S.C. §202(c), it is hereby acknowledged that the U.S. Government has certain rights in the invention described herein, which was made, at least in part, with funds from the Department of Defense.

### FIELD OF THE INVENTION

The invention relates to surfactants, referred to herein generally as “shamrock surfactants”, which have a variety of applications, including without limitation, chemical decontamination of mustard, storage and release devices, chemical switches and remediation of water contaminated with heavy metal ions.

Shamrock surfactants have the general structure 1. The darkened circles represent charged and/or polar nonionic head groups, and the wavy lines, hydrocarbon chains. Thus the surfactants contain two outer head groups connected to a central head group by hydrocarbon chains. The term “shamrock” denotes their triple-headed character, reflecting the fact that shamrocks have leaflets in groups of three.

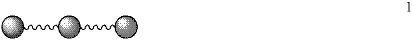

### BACKGROUND OF THE INVENTION

Surfactants are important in a broad spectrum of applications as diverse as oil recovery¹ and drug delivery². Over the past few years there has been increasing activity in the synthesis of novel functionalized and unfunctionalized surfactants, which has been driven by a variety of factors.³ For example, many new surfactants have been designed for specific applications, and others have been synthesized in a search for novel and interesting properties. The former include cleavable surfactants^{4,5} and the latter, gemini surfactants.⁶

The synthesis of novel surfactants and the characterization of their properties, even without preconceived applications, are indeed worthwhile endeavors, as evidenced by the success of gemini surfactants. They have been shown to have unique physical properties, compared to conventional surfactants, and have been used to advantage in a number of important applications, such as skin care formulations, antibacterial regimens, and the preparation of high-porosity materials.

F. M. Menger has reported surfactants 2 (n=8, 12, and 16),⁸ which, upon ionization of their carboxyl groups, may considered analogous to shamrock surfactants. Other known surfactants such as 3⁹ and 4 (n=10, 12, 14, 16)¹⁰ contain three head groups, but they are not shamrock surfactants. The major lipophilic character of surfactants such as 3 is provided by three alkyl chains, whereas that of shamrock surfactants 1 is provided only by the two hydrocarbon chains linking the three head groups. Shamrock surfactants are structurally related to, but are more complex than, bola surfactants, which contain two head groups connected by one or more hydrocarbon chains, as in 5.¹¹ Also related, but structurally distinct, are hyperextended surfactants, such as 6,¹² and ionene polyelectrolytes, such as 7 (n=ca. 30).¹³

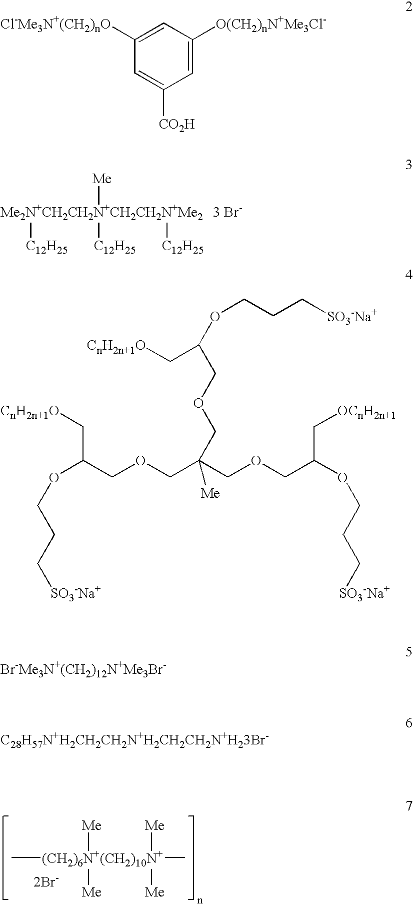

### SUMMARY OF THE INVENTION

In accordance with one aspect of the present invention, there is provided a surfactant compound of the formula:
[X-L-Z-L′-X′] (A)p (I)
wherein X and X′ represent outer head groups, which may be the same or different and comprise charged moieties selected from the group of —N+R¹R²R³, R¹, R² and R³ being the same or different and representing hydrocarbyl groups, —CO₂⁻ or —O(CH₂)ₘSO₃⁻, m being an integer from 2 to 30, or polar moieties of the formula, —O—(CH₂CH₂O)ₙ—R⁴, R⁴ being a C₁-C₆ hydrocarbyl group and n is an integer from 1 to 1000; L and L′ are the same or different and represent a hydrocarbon linking moiety which may optionally be interrupted with oxygen; Z represents a central head group selected from a dithiophosphate moiety, 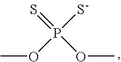
a dithiocarbamate moiety, 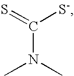
or a quaternary ammonium moiety, 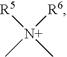
wherein R⁵ and R⁶ are the same or different and represent C₁-C₆ hydrocarbyl groups, with the proviso that when Z represents the aforementioned dithiocarbamate moiety or said quaternary ammonium moiety, X and X′ do not represent NR¹R²R³, and with the further proviso that X and X′ do not represent —O(CH₂)ₘSO₃— unless Z represents said quaternary ammonium moiety; and A represents a counter ion, which may be either positive or negative depending on the net charge of [X-L-Z-L′-X′] and p is an integer which when multiplied by the valency of said counter ion yields the absolute value of the net charge of [X-L-Z-L′-X′].

One series of shamrock surfactants, in accordance with the invention, comprises Phosphorodithioate (Dithiophosphate)-Based Surfactants and includes surfactants 8-10, which contain a central (nucleophilic)¹⁴ dithiophosphate group. In addition, 8, 9, and 10 contain two cationic, two anionic, and two polar nonionic head groups, respectively, resulting in net charges of 1⁺, 3⁻, and 1⁻, respectively, for their organic units.

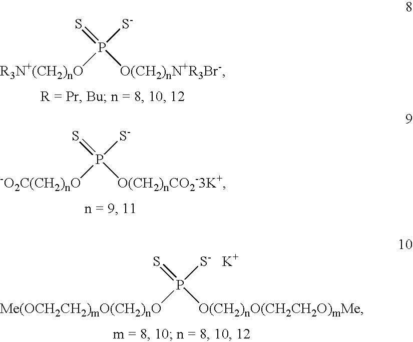

Another series of shamrock surfactants comprises Dithiocarbamate-Based Surfactants and includes surfactants 21 and 22, which contain a central (nucleophilic)¹⁴ dithiocarbamate group. In addition, 21 and 22 contain two anionic and two nonionic head groups, resulting in net charges of 3⁻ and 1⁻, respectively, for their organic units.

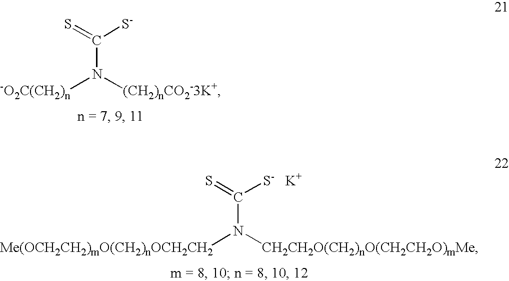

A further series of shamrock surfactants comprises Quaternary Ammonium-Based Surfactants and include surfactants 31-33, which contain a central quaternary ammonium group. In addition, 31, 32, and 33 contain two cationic, two polar anionic, and two nonionic head groups, resulting in net charges of 3⁺, 1⁻, and 1⁺, respectively, for their organic units.

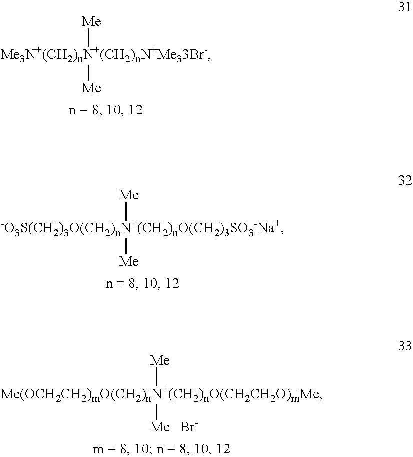

In accordance with another aspect of this invention, there is provided a process for the chemical decontamination of mustard (i.e. ClCH₂CH₂SCH₂CH₂Cl), which involves reacting mustard with aggregates of a surfactant compound of the above-described formula (I), above, wherein the central head group is a dithiophosphate moiety or a dithiocarbamate moiety, under conditions causing a residue of mustard to be chemically bound to the surfactant compound by a nucleophilic substitution reaction, thereby producing the desired decontamination.

An important practical advantage of this method, as compared to known mustard decontamination methods involving nucelophilic substitution reactions, is that the decontaminated mustard becomes part of a surfactant. This feature can be exploited in water remediation. The derived aggregated surfactant, containing the mustard residue, can be removed from the aqueous reaction mixture by ultrafiltration. Such a filtration will retain aggregated surfactant, while allowing water to pass through the filter. Overall, the decontamination process, followed by ultrafiltration, will result in remediatidn of water that has been contaminated with mustard.

The present invention also provides a method for controlling release of a material contained or stored within a surfactant aggregate. This method comprises the steps of: a) providing an aggregated surfactant composed of at least one surfactant compound of formula (I) above, in which the central head group is a dithiophosphate moiety or a dithiocarbamate moiety, with the material being contained within the aggregated surfactant; and b) oxidizing the aggregated surfactant, thereby producing a disulfide-linked dimer composed of the surfactant compounds, and releasing the material from the surfactant aggregates.

In one embodiment of the controlled-release method of the invention, the aggregated surfactant is composed of a surfactant compound wherein the central head group is a dithiophosphate moiety as described above, the linking moieties are the same straight or branched chain hydrocarbon moieties having 6 to 30 carbon atoms and the outer head groups are the same —NR¹R²R³, —CO₂⁻ or —O—(CH₂CH₂O)ₙ—R⁴ group, R¹, R² and R³ being the same or different and representing hydrocarbyl groups, R⁴ being a hydrogen or a C₁-C₆ hydrocarbyl group and n is an integer from 1 to 1000.

According to another embodiment of the controlled release method of this invention, the aggregated surfactant is composed of a surfactant compound wherein the central head group is a dithiocarbamate moiety, the linking moieties are the same straight or branched chain hydrocarbon moieties having 6 to 30 carbon atoms or straight or branched chain hydrocarbon moieties having 6 to 30 carbon atoms which are interrupted with oxygen, and the outer head groups are the same —CO₂⁻ or —O—(CH₂CH₂O)ₙR⁴ group, R⁴ being hydrogen or a C₁-C₆ hydrocarbyl group and n is an integer from 1 to 1000.

According to a further aspect of this invention, there is provided a process for removing heavy metal ions from a liquid medium containing same. This method comprises adding to the liquid medium a shamrock surfactant as described above, in an amount effective to form aggregates comprising the surfactant compound complexed with the heavy metal ions. Thereafter, the liquid medium is filtered to separate the resulting aggregates from the liquid medium.

The process for removing heavy metal ions from a liquid medium in accordance with this invention may include the further step of oxidizing the aggregates in a reaction medium to release the heavy metal ions, thereby forming aggregates comprising dimers composed of the surfactant compounds linked through their central head group; and separating the resulting dimer-containing aggregates from the reaction medium, so that the surfactant compound can be regenerated from the dimers and recycled to the process.

Previously, metal ions have been removed from water by micellar-enhanced ultrafiltration (MEUF), as well as by ligand-modified MEUF. Generally, MEUF involves electrostatic binding of metal cations to anionic micelles/aggregates of surfactants such as sodium dodecyl sulfate. Ligand-modified MEUF involves a host micelle/aggregate containing a lipophilic ligand that coordinates to metal ions. Shamrock surfactants, however, offer a superior type of ligand-based separation process. With shamrock surfactants, no host surfactant is required, because the aggregate-forming surfactant also contains the ligand. Also, as noted above, the use of shamrock surfactants allows for their regeneration and recycling in the water remediation process.

### BRIEF DESCRIPTION OF THE DRAWING

FIG. 1 is an image obtained by phase contrastoptical microscopy of aggregates formed by Surfactant 8 with R=Bu, n=10, and NO₃⁻ exchanged for Br⁻. Scale bar=50 μm.

### DETAILED DESCRIPTION OF THE INVENTION

The term “hydrocarbyl”, as used herein, refers to an unsubstituted or substituted, saturated or unsaturated hydrocarbon radical containing from about 1 to 30 carbon atoms, which may be an aliphatic, cycloaliphatic or aromatic hydrocarbon group. When substituted, hydrocarbyl groups may be substituted at any available point of attachment. When the hydrocarbyl group is said to be substituted with a hydrocarbyl group, this is used interchangeably with “branched hydrocarbyl group”. Exemplary unsubstituted hydrocarbon radicals include alkyl groups such as methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl, octadecyl, nonadecyl, eicosyl, heneicosyl, docosyl, tricosyl, tetracosyl, pentacosyl, and the like; alkenyl groups such as vinyl, allyl and the like; aromatic groups such as phenyl, tolyl, xylyl, napthyl, biphenyl, and the like; aralkyl groups such as benzyl, phenethyl, phenpropyl, phenbutyl, phenhexyl, napthoctyl, and the like; and cycloalkyl groups such as cyclopropyl, cyclobutyl, cyclohexyl, cycloheptyl, cyclooctyl, and the like. Exemplary substituents may include but are not limited to one or more of the following groups: halo (such as F, Cl, Br, I), alkoxy, alkylthio, hydroxy, carboxy (—COOH), amino (—NH₂), monoalkylamine (—NHR), dialkylamine (—NR₂), or thiol (—SH), wherein R in the aforementioned substituents represents a hydrocarbyl radical. Hydrocarbyl groups may also be interrupted with at least one oxygen, nitrogen, or sulfur atom.

The term “hydrocarbon linking moiety”, as used herein, refers to a divalent hydrocarbon moiety of 6 to 30 carbon atoms in length, which may be saturated or unsaturated.

Surfactants 8, which are mentioned above, may be synthesized in three straightforward steps as illustrated (eq 1), starting from commercially available (Aldrich) bromo alcohols 10 (n=8, 10, 12). The nucleophilic substitution reaction of R₃N (R=Pr, Bu) with 11 will give 12.¹⁵ Then 12 may be converted into acid 13 by reaction with phosphorus pentasulfide, according to modified literature procedures.¹⁶ Finally, a dichloromethane solution of 13 will be washed with water to give 8. In this process, the dithiophosphoric acid unit of 13 undergoes ionization, with the net loss of HBr. [The pKa of (MeO)₂PS₂H=1.55 in 93:7 H₂O— EtOH.¹⁷] Surfactants 8 preferably contain propyl or butyl groups on their quaternary ammonium nitrogens instead of methyl groups, which are generally used as the short-chain components of quaternary ammonium surfactants. Methyl-substituted quaternary ammonium groups would be more susceptible to the possibility of S_{N}2 substitution at the methyl carbon by the nucleophilic dithiophosphate head group.¹⁴ Average relative rates for alkyl substrates in S_{N}2 reactions are Me (30); Et (1); Pr (0.4); Bu (0.4).¹⁸ In preliminary work, we have prepared two shamrock surfactants: 8 with R=Bu and n=10; and 8 with R=Bu, n=10, and NO₃⁻ exchanged for Br⁻.¹⁹

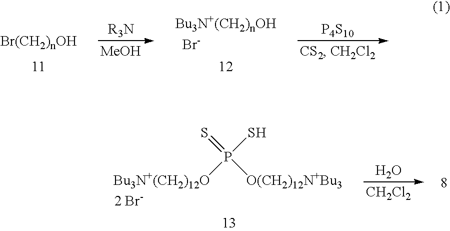

Surfactants 9 may be synthesized as illustrated (eq 2), starting with 14 (n=9, 11), which is obtained by Fischer esterification of the corresponding commercially available (Aldrich) ω-hydroxy carboxylic acids. There is a potential complication in the conversion of 14 into 15, namely the possibility of the reaction of 14's ester group with P₄S₁₀. It is known that esters of carboxylic acids can be converted into thiocarboxylic O-esters [RC(═S)OR′] with P₄S₁₀, but the yields are typically very low (ca. 10%).²⁰ With use of the (normal) stoichiometric amount of P₄S₁₀ in its reaction with 14,¹⁶ this undesirable side reaction should be precluded. The conversion of 15 into 9 by basic hydrolysis of its carboxylic ester groups may be straightforward, given the stability of the dithiophosphate group (see below).

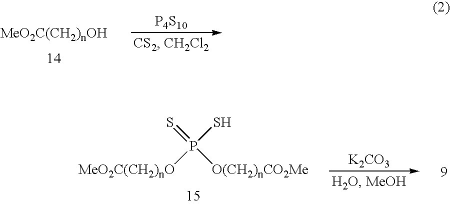

Surfactants 10 may be synthesized as illustrated (eq 3), starting with known polyethylene glycol monomethyl ethers 16 (m=8, 10),²¹ which may be prepared according to their literature procedures.²¹ The alkylation of 16 with bromo ester 17 (n=8, 10, 12), prepared by the acetylation of 11, will give 18. Then 19, obtained by hydrolysis of 18, may be converted into surfactants 10.

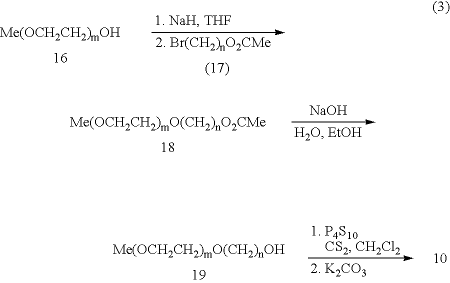

The dithiophosphate groups of 8-10 almost certainly would be stable with respect to hydrolysis in water, based on literature precedent.²² No hydrolysis of the sodium salt of 20 was detected during 134 h at 65° C. in 4 M NaOH. On the other hand, acid 20 itself hydrolyzes under forcing conditions. At 65° C., 20 underwent ca. 50% hydrolysis during 24 h in contact with water or 4 M hydrochloric acid. But at 25° C., 20 underwent <10% hydrolysis during 5 months in contact with water or 1 M hydrochloric acid.²²

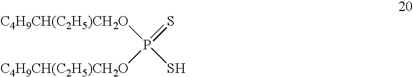

Surfactants 21 may be synthesized as illustrated (eq 4), starting with diester amines 23 (n=7, 9, 11), which may be prepared by the literature procedure²³ for the known homologue with n=5. The reaction of 23 with carbon disulfide to give 24 may be performed according to modified literature procedures²⁴ that we have successfully applied to the synthesis of other dithiocarbamate surfactants.²⁵ Then 24 may be subjected to basic hydrolysis of its ester groups and deprotonation to give 21.

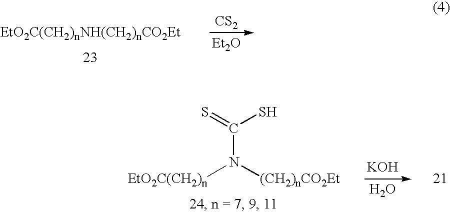

Surfactants 22 may be prepared as illustrated (eq 5). The alkylation of alcohol 19 (see eq 3) with chloroacetic acid according to a literature procedure²⁶ for a related compound may give acid 25 (m=8, 10; n=8, 10, 12), which may be converted into amine 27 through ester 26. Then, the reaction of 26 and 27 will yield amide 28, which may be reduced to amine 29, followed by its conversion^{24,25} into 22.

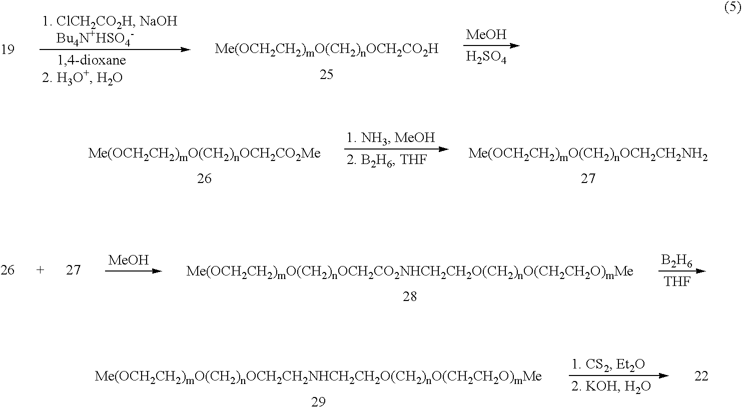

The anionic dialkyldithiocarbamate groups of 21 and 22 are expected to be stable over extended periods (days) in water at pH >7, based on literature precedent.^{27,28,29} Solid 30, which was prepared by a route analogous to those above, was unchanged after an extended period at 23° C.²⁵ The pKa of N,N-diethyldithiocarbamic acid is 4.04.^{30a}

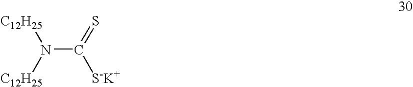

Surfactants 31 may be synthesized as illustrated (eq 6), starting with triamines 34 (n=8, 10, 12), which may be prepared by the literature procedures³¹ employed for such triamines. Ion exchange is effective to replace iodide by bromide.

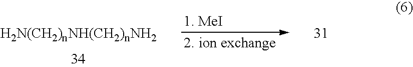

Surfactants 32 may be synthesized as illustrated (eq 7). The quaternization of dimethylamine with bromo alcohols 11 (n=8, 10, 12) yields quaternary ammonium surfactants 35, which may be alkylated with 1,3-propane sultone to give 32. If the alkylation reaction is unsuccessful in THF, the indicated solvent, a more polar, but less convenient, solvent such as dimethyl sulfoxide may be used.

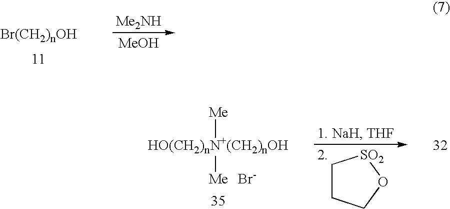

Surfactants 33 may be prepared by the alkylation of 35 (n=8, 10, 12) with 36 (m=8, 10) as illustrated (eq 8).

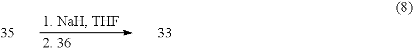

Compound 36 may be obtained as shown from polyoxyethylene glycol monomethyl ethers 16.

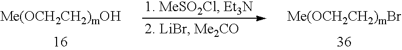

The surfactants described herein may assume various forms, including micelles and vesicles (liposomes)³² and, in some instances, more complex supramolecular structures. The aggregate morphologies can be characterized by a combination of ¹H and ³¹p NMR spectroscopy, dynamic laser light scattering (DLLS), differential scanning calorimetry (DSC), phase-contrast optical microscopy, and in-lens cryo-high resolution scanning electron microscopy (cryo-HRSEM).

The analysis of an aqueous solution/dispersion of a surfactant by ¹H NMR, and as appropriate by ³¹P NMR, provides an initial indication of the size of its aggregates. Micelles and small unilamellar vesicles (SUVs), formed by sonication, generally give high resolution ¹H and ³¹P NMR spectra, and larger aggregates often give spectra with significant line-broadening or the absence of signals.^{33,34} The sizes of micelles and SUVs can be determined by DLLS, and those of giant vesicles (GVs),³⁵ formed by the hydration of surfactant thin films or smears, by phase-contrast optical microscopy. The phase transition temperatures of (vesicle) bilayers can be determined by DSC.³⁶ Aggregates whose morphologies cannot be determined by DLLS and optical microscopy can be subjected to cryo-HRSEM.³⁷

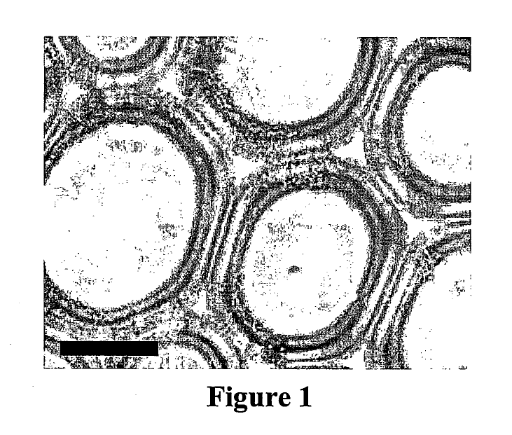

In preliminary work,¹⁹ it has been observed by optical microscopy that shamrock surfactant 8, with R=Bu, n=10, and NO₃⁻ exchanged for Br⁻, forms the aggregates shown in FIG. 1, upon the hydration of a smear in water at 23° C. (size bar=50 μm). At this time, the detailed nature of these aggregates is unclear, but it appears that they correspond to droplets of a one-component coacervate.³⁸

As noted above, three specific applications of several of the shamrock surfactants described herein are within the scope of the present invention. The first involves the chemical decontamination of mustard; the second involves storage and release devices and chemical switches; and the third, the remediation of heavy-metal ion-contaminated water.
Chemical Decontamination of Mustard. Chemical warfare agents such as mustard, a blistering agent, and VX, a nerve agent, continue to represent significant military and terrorist threats. A rouge nation will undoubtedly possess the capability to manufacture and use chemical weapons. This was clearly demonstrated in the 1980-98 Iran-Iraq War. And it is likely that U.S. troops were exposed to chemical agents in the 1991 Persian Gulf War. Urban terrorists represent a real threat too, as evidenced by their use of a nerve agent in the Tokyo, Japan subway in 1995. Chemical weapons are indeed insidious. They are deadly offensive weapons, and many are easy to make in large quantities by relatively straightforward, “bathtub” chemistry. Thus chemical weapons have been described as the “poor man's nuke”. They will continue to be a major concern to the world for the foreseeable future.

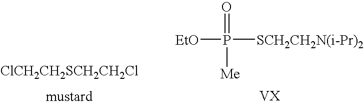

The paramount issue in dealing with chemical agents is their decontamination. There are several approaches to such decontamination.³⁹ In particular, chemical decontamination corresponds to the conversion of agents into nontoxic compounds by chemical reactions.³⁹ Reported strategies for the chemical decontamination of mustard and its simulants include nucleophilic substitution,^{14,16,39,40} hydrolysis,^{39,41,42} oxidation,^{39,43} and elimination reactions.³⁹ In the work outlined below, decontamination is effected by nucleophilic substitution reactions.

Vesicles and other aggregates of dithiophosphate-based surfactants 8-10 and dithiocarbamate-based surfactants 21 and 22, as discussed above, are expected to have utility in the chemical decontamination of mustard. Simulants 37 and 38 can be used in place of mustard itself to demonstrate such utility. A simulant generally displays the chemical and physical properties of the actual agent but is much less toxic. Immediately below, only reactions with 37 are illustrated; those with 38 are generally analogous and should be faster. The relative hydrolysis rates for 37, 38, and mustard are 0.095, 5.9, and 1.0, respectively, at 25° C.⁴⁴ Thus, the reactivities of 37 and 38 bracket that of mustard.

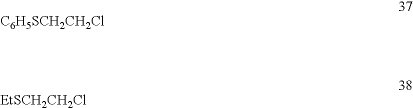

The reactions of vesicular surfactant 39 with simulants 37 and 38 (and homologues of 38 with Me or Bu substituted for Et) have previously been studied.^{16,40} In each case, 39 undergoes alkylation at sulfur by the simulant, as illustrated for the reaction with 37, which gives 40 (eq 9). The present invention also demonstrated the intermediacy of episulfonium ion 41 in this reaction, which is formed by the ionization of 37 (eq 10).¹⁶ The nucleophilic dithiophosphate group of 39 captures 41to give 40.

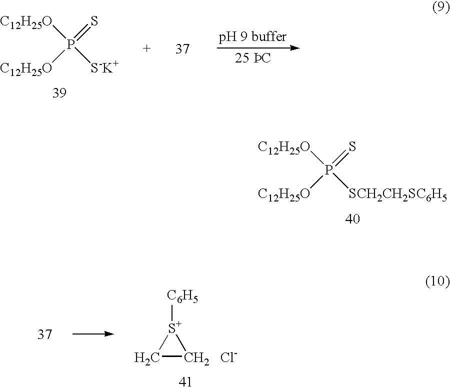

Based upon the experience of the present inventors with surfactant 39^{16,40} it is anticipated that surfactant 8 will react with 37 to give 42 (eq 11) in a process that involves the following. Simulant 37, which is insoluble in water alone, is solubilized by aggregated 8. At the polar aggregate-water interface, 37 ionizes to give ion 41, which is captured by 8 to yield 42, resulting in the chemical decontamination of simulant 37. Derived surfactant 42 will form mixed aggregates with 8 as it is formed. It is noteworthy that the success of 8 in capturing episulfonium ion 41 results from the substantial nucleophilicity of its dithiophosphate head group.¹⁴ The nucleophilicities of a large number of nonsurfactant species with respect to mustard have been determined.¹⁴ The reactions of dithiophosphate-based surfactants 9 and 10 with simulant 37 (not shown) will be analogous to eq 11.

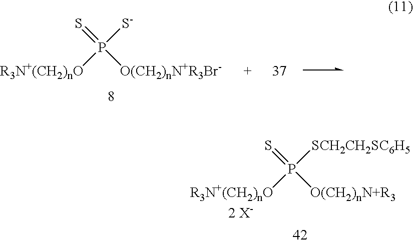

The reaction of surfactant 21 with simulant 37 to give 43 is illustrated (eq 12), and that of 22 with 37 (not shown) should proceed analogously. These reactions are expected to involve the capture of episulfonium 41 by 21 and 22's dithiocarbamate groups.

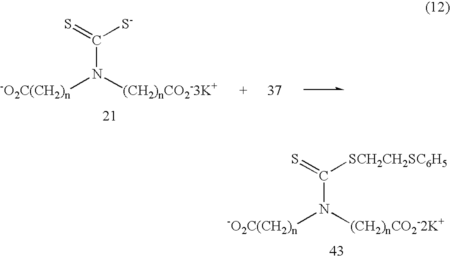

It is important to note that surfactants 21 and 22 will almost certainly be more efficient than 8-10 in decontaminating simulant 37, based upon the reported greater nucleophilicity of the N,N-diethyldithiocarbamate anion (44) compared to the O,O′-diethyldithiophosphate anion (45).¹⁴ Competition factors of 34,000 and 2,600 M⁻¹ have been reported⁶ for 44 and 45, respectively, relative to water (pH 8, 25° C.) in the capture of 46, the episulfonium ion derived from mustard itself. Thus 44 is more than an order of magnitude more nucleophilic than 45 with respect to 46.

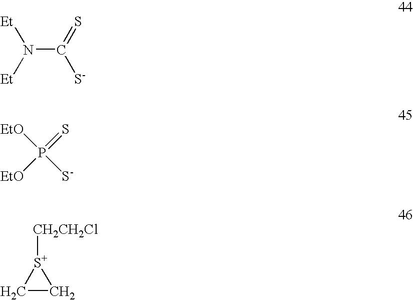

The anticipated greater nucleophilicity of the dithiocarbamate surfactants 21 and 22, compared to 8-10, has a significant beneficial consequence, as follows. Simulant 38 is fully decontaminated by hydrolysis in water only when it is completely converted into alcohol 48, involving initial ionization to episulfonium ion 47, followed by its capture by water (eq 13). However, such complete conversion occurs only when the concentration of 38 is kept low (≦0.001 M) and it is added to water as a concentrated solution in a polar organic solvent.⁴² At higher concentrations of 38, the system is much more complicated, because ions 49 and 50 are formed in addition to, and in greater amounts than, alcohol 48, by the capture of episulfonium ion 47 by 48 and 38, respectively (eq 14). Mustard itself behaves analogously, and it is believed that its analogues of 49 and 50 are responsible for the recurring toxicity of mustard in humans and in the environment.⁴² [Simulant 37, unlike 38 and mustard, hydrolyzes cleanly to the corresponding alcohol (C₆H₅SCH₂CH₂OH) in water, without the accompanying formation of ions analogous 49 and 50.¹⁶]

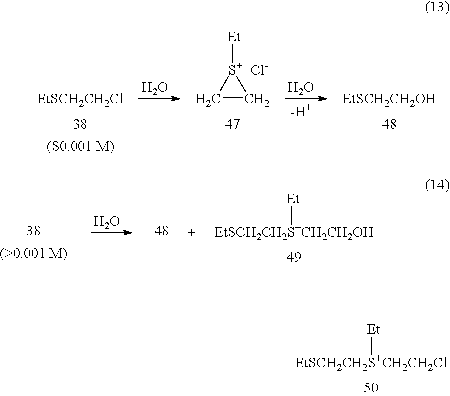

The very important practical consequence of the above is that decontamination methods for 38 (and mustard itself) must minimize, or preferably totally avoid, the formation of ions 49 and 50 (and mustard's analogues). It has been reported⁴⁰ that the reaction of equimolar amounts of 38 (0.0099 M if fully dissolved) and 39's SUVs gave an 89% yield of 51 (eq 15). The 11% of 38 not transformed into 51 was converted into a mixture of ions 49 and 50 and a lesser amount of alcohol 48. The use of dithiocarbamate surfactants 21 and 22 should result in substantially more efficient decontamination of 38, involving their alkylation reactions, with little or no concomitant formation of toxic 49 and 50, since these surfactants are much more nucleophilic than 8-10, as noted above.

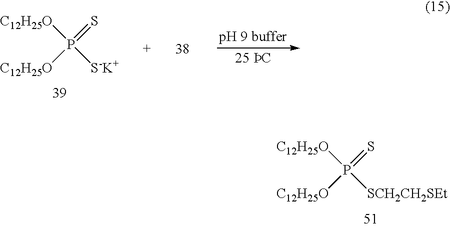

Yang and co-workers reported⁴² that in 50 vol % aqueous acetone at 20 C, the thiosulfate anion (S₂O₃²⁻) reacts with simulant 38 to give 52 without the formation of any 48, 49, or 50. Thus thiosulfate captures 47 to the exclusion of capture by water, 48, or 38, respectively. It is known that thiosulfate has a competition factor of 27,000 M⁻¹ relative to water in the capture of episulfonium ion 46.¹⁴ Since the competition factors for dithiocarbamate surfactants 21 and 22 are expected to be about 34,000 M⁻¹ (see above), they should also react with 38 without the formation of any 48-50.

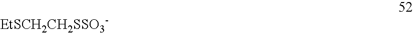

An important novel feature of decontamination with dithiophosphate surfactants 8-10 and dithiocarbamate surfactants 21 and 22, compared to that with dithiophosphate surfactant 39 and other nucelophilic substitution methods, is that the decontaminated simulant (mustard) becomes part of a surfactant. For example, simulant 37 is converted into surfactants 42 (eq 11) and 43 (eq 12) by surfactants 8 and 21, respectively. This feature can be exploited in water remediation as exemplified with simulant 37. After the conversion of 37 into surfactant 42(43), the reaction mixture is subjected to ultrafiltration. Such a filtration would retain aggregated 42(43), while allowing water to pass through the filter. Overall, the decontamination process, followed by ultrafiltration, would result in remediation of water that had been contaminated with 37.

Storage and Release Devices and Chemical Switches.

Vesicles and other aggregates derived from dithiophosphate-based surfactants 8-10 and dithiocarbamate-based surfactants 21 and 22 can be used as reversible storage and release devices, and chemical switches. There have been numerous reports of surfactant systems that can serve as storage and release devices^{45,46} and as chemical switches,^{47,48} which are activated by a variety of chemical and physical processes.

Such applications of 8-10 and 21 and 22 involve their oxidation to disulfide-linked dimers A and B, respectively, and reduction back to the parent shamrock surfactants, as illustrated (eqs 16 and 17). Each oxidation involves a change in the shape and charge of the surfactant unit: 1⁺−>4⁺for 8 to A; 3⁻−>4⁻ for 9 to A, and for 21 to B; and 1⁻−>0 for 10 to A, and for 22 to B. It is reasonable to expect that some of these redox reactions will involve a change in aggregate morphology,³⁴ which will form the basis for both the storage and release, and chemical switch functions. In particular, a change in morphology from closed bilayer vesicles to micelles would be appropriate for the former function.

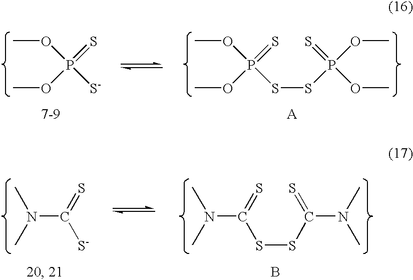

It is known that dithiophosphates and dithiocarbamates can be oxidized^{30b,50} to their disulfide-linked dimers. Many oxidizing agents⁵⁰ can be used, including household bleach and hydrogen peroxide, and a variety of reducing reagents⁵¹ can be used to effect the reverse reaction. In particular, since surfactant dimers A and B should remain in solution upon their formation (assuming Tₖ values of 23° C.), water-soluble reducing agents such as sodium borohydride and dithiothreitol [HSCH₂CH(OH)CH(OH)CH₂SH]⁵² can be used to convert them back to the parent shamrock surfactants. The reduction of the positively-charged dimer A derived from 7 (see 39 below) by the former will be facilitated by the electrostatic accumulation of BH₄⁻ by its positively-charged aggregates.

In preliminary work,¹⁹ it has been demonstrated that vesicular surfactant 36 can be converted into 37 by oxidation with household bleach (NaOCl) within 10 min, or with hydrogen peroxide within 60 min at 23° C. (eq 18). This conversion would result in the release of compounds entrapped within the water compartments of 36's vesicles, because 37, a high-molecular weight, neutral compound, does not support vesicle formation. In fact, 37 precipitates from solution as an oil. 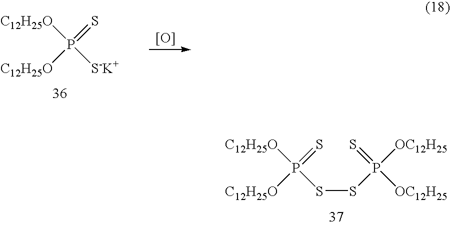
Remediation of Heavy-Metal Ion-Contaminated Water.

Metal ions have been removed from water by micellar-enhanced ultrafiltration (MEUF),⁵³ as well as by ligand-modified MEUF.^{54,55} Generally, MEUF involves electrostatic binding of metal cations to anionic micelles of surfactants such as sodium dodecyl sulfate. Ligand-modified MEUF involves a host micelle containing a lipophilic ligand that coordinates to metal ions. Shamrock surfactants offer a different and perhaps superior type of ligand-based separation process. With them, no host surfactant is required, because the aggregate-forming surfactant also contains the ligand.

Shamrock surfactants 8, 10, and 22 can be used in the remediation of water (and other materials) contaminated with heavy-metal ions (Mⁿ⁺). The Surfactant 8 would be applied in water remediation as shown in the Scheme outlined below. Upon the addition of 8 to contaminated water, the dithiophosphate groups of one or more of its surfactant cations will coordinate with heavy-metal ions to form aggregated complexes 54 in Step 1. In Step 2, ultrafiltration of the system will retain the aggregated complexes, while allowing water to pass through the filter, devoid of heavy metals. The goal of water remediation can thus be achieved. Importantly, this system also provides for the recycling of 54 back to 8 for further use. Accordingly, in Step 3, aggregated complexes 54 will be oxidized to give (aggregated) surfactant 55. Note that this reaction converts the coordinated, negatively-charged dithiophosphate group of 54 into the neutral disulfide-linked dithiophosphate group of 55 and releases Mⁿ⁺ in the process. Then another ultrafiltration in Step 4 will retain aggregated 55 while allowing water containing Mⁿ⁺ to pass through the filter. Lastly, in Step 5, the disulfide linkage of 55 will be reduced to regenerate 8. The oxidizing and reducing agents used in Steps 3 and 4, respectively, will be those used above in the storage and release, and chemical switch applications.

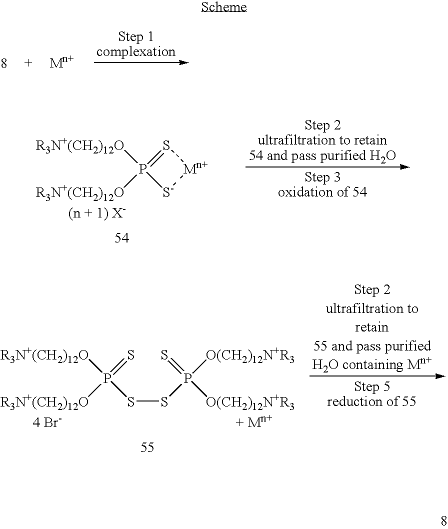

The use of surfactants 10 and 22 in water remediation would be analogous to that of surfactant 8, as exemplified below for the latter. Complex 56, derived from one or more of 22 and Mⁿ⁺, will be oxidized to surfactant disulfide-linked dimer 57 (eq 19), which will be reduced to regenerate 22. The efficient complexation of heavy-metal ions by dithiophosphate⁵⁶ and dithiocarbamate^{30C} groups is well known. Surfactants 9 and 21 would not be appropriate for use in water remediation, because their carboxylate groups would compete with their dithiophosphate and dithiocarbamate groups, respectively, in complexation of the heavy-metal ions.

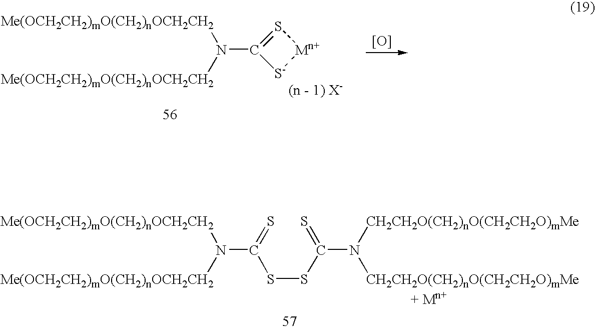

Shamrock surfactants 8, 10, and 22 are expected to form complexes with ions of metals such as Cd, Cr, Co, Cu, Hg, Ni, Pb, and Zn, using the semi-equilibrium dialysis method, which has been employed in the evaluation of various ligands in ligand-modified MEUF.⁵⁴

The shamrock surfactants should be useful in their applications as micelles, vesicles, or other aggregate types as appropriate. For those surfactants that form vesicles, both SUVs and GVs can be employed. Above it was noted that shamrock surfactant 7, with R=Bu, n=10, and NO₃⁻ exchanged for Br⁻, may form a one-component coacervate. A surfactant coacervate phase has been used to extract chlorinated aliphatic compounds form water.⁵⁷

The following examples present further detail regarding the practice of the instant invention. These examples are provided for illustrative purposes only and are not intended to limit the scope of the invention in any way.

### EXAMPLE 1

Shamrock surfactants 58a and 58b were synthesized in four steps as illustrated below (eq 20), starting with the conversion of commercially available diol 59 into bromo alcohol 60. The nucleophilic substitution reaction of R₃N (R=CH₃CH₂CH₂ or CH₃CH₂CH₂CH2) with 60 gave surfactants 61a and 61b. Then 61a and 61b were converted into compounds 62a and 62b, respectively, by reaction with phosphorus pentasulfide. Finally, dichloromethane solutions of 62a and 62b were washed with water to give 58a and 58b, respectively. In this process, the dithiophosphoric acid units of 62a and 62b undergo ionization, with the net loss of HBr.

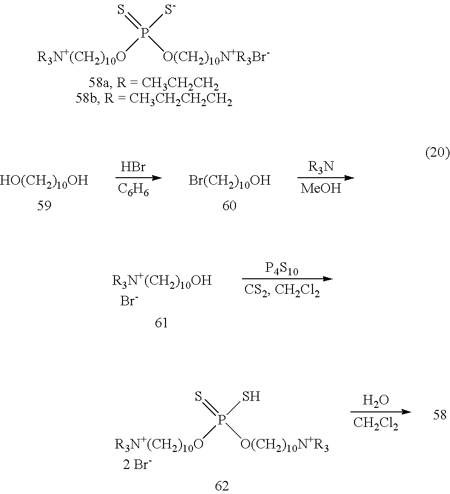

### EXPERIMENTAL SECTION

General Procedures. ¹H (400 MHz) and ¹³C (100.6 MHz) NMR spectra (23° C.) were recorded in the following solvents with the indicated internal standards (relative to Me₄Si): CDCl₃, residual CHCl₃ (δ 7.27) and CDCl₃ (center line at δ 77.00), respectively; CD₂Cl₂, residual CHDCl₂ (center line at δ 5.32) and CD₂Cl₂ (center line at δ 54.00), respectively; D₂O, residual HOD (δ 4.80) for ¹H NMR. ³¹P NMR (162.1 MHz) spectra were recorded in CD₂Cl₂ and D₂O with 85% H₃PO₄ as external standard.

Electrospray (ES) mass spectra (positive ion mode) of surfactants 58 were obtained on a Thermo-Finnigan LCQ instrument.

10-Bromo-1-decanol (60). A modified literature procedure⁵⁸ was used to convert 17.4 g (0.100 mol) of commercially available 1,10-decandiol (59) into 23.0 g of crude product. This material was column chromatographed on silica gel with elution by 1:5 (v/v) ethyl acetate-hexane to give 18.2 g (77%) of 60 as a wax: ¹H NMR (400 MHz, CDCl₃) δ 3.65 (t, 2H, CH₂O), 3.42 (t, 2H, CH₂Br), 1.86 (p, 2H, CH₂CH₂Br), 1.57 (p, 2H, CH₂CH₂O), 1.35 (m, 13H, OH, (CH₂)₆); ¹³C NMR (100.6 MHz, CDCl₃) δ 63.28, 34.30, 32.98, 29.91, 29.71, 29.68, 29.59, 28.94, 28.36, 25.92.

10-Hydroxy-N,N,N-tripropyldecan-1-aminium Bromide (61a). A modified literature procedure⁵⁹ was used. A mixture of 32.83 g (22.91 mmol) of tripropylamine, 5.44 g of 60, and 150 mL of C₂H₅OH was refluxed for 5 days and then rotary evaporated. A solution of the residue in 50 mL of H₂O was extracted with two 30-mL portions of Et₂O and then 25 mL of ethyl acetate. The aqueous solution was adjusted to pH ca. 10 with solid K₂CO₃ and extracted with two 30 mL-portions of diethyl ether. After H₂O was removed by rotary evaporation, 60 mL of CHCl₃ was added to the residue, and the resultant mixture was filtered and rotary evaporated to give 7.88 g (90%) of 61a as wax: ¹H NMR (100.6 MHz, D₂O) δ 3.57 (t, 2H, CH₂O), 3.14 (m, 8H, (CH₃CH₂CH₂)₃N⁺CH₂), 1.67 (m, 8H, (CH₃CH₂CH₂)₃N⁺CH₂CH₂), 1.52 (m, 2H, CH₂CH₂O), 1.40 (m, 12H, NCH₂CH₂(CH₂)₆), 0.92 (t, 9H, 3 CH₃); ¹³C NMR (100.6 MHz, D₂O) δ 61.69, 59.60, 58.25, 31.07, 28.31, 28.26, 28.18, 27.92, 25.29, 24.83, 20.77, 14.65, 9.64; IR (NaCl) 3275 (br), 2916 (vs), 1659 (m), 1487 (s), 1381 (s), 1057 (s), 1007 (m), 965 (m), 763 (m), 634 (m) cm⁻¹. Anal. Calcd for C₁₉H₄₂BrNO. 0.5H₂O: C, 58.60; H, 11.13. Found: C, 58.32; H, 10.86.

10-Hydroxy-N,N,N-tributyldecan-1-aminium Bromide (61b). The procedure for surfactant 61a was used, starting with a reaction mixture of 60.29 g (0.325 mol) of tributylamine, 7.76 g of 60, and 200 mL of C₂H₅OH, which gave 12.0 g (87%) of 61b as a wax: ¹H NMR (100.6 MHz, D₂O) δ 3.62 (t, 2H, CH₂O), 3.22 (m, 8H, (CH₃CH₂CH₂CH₂)₃N⁺CH₂), 1.67 (m, 8H, (CH₃CH₂CH₂CH₂)₃N⁺CH₂CH₂) 1.57 (m, 2H, CH₂CH₂O), 1.40 (m, 18H, (CH₃CH₂CH₂CH₂)₃N⁺CH₂CH₂(CH₂)₆), 0.98 (t, 9H, 3 CH₃); ¹³C NMR (100.6 MHz, D₂O) δ 61.75, 58.12, 57.97, 31.12, 28.32, 28.16, 27.88, 25.26, 24.87, 23.01, 20.75, 19.02, 12.70; IR (NaCl) 3321 (br), 2959 (vs), 2927 (vs), 2856 (vs), 1486 (s), 1381 (m), 1058 (s), 883 (m), 747 (m) cm⁻¹. Anal. Calcd for C₂₂H₄₈BrNO. 0.5H₂O: C, 61.23; H, 11.45. Found: C, 61.54; H, 11.37.

O,O′-Di-[10-(N,N,N-tripropylanmmonio)decyl] phosphorodithioate Bromide (58a). A solution of 0.250 g (0.657 mmol) of surfactant 61a , 0.0370 g (0.0821 mmol) of phosphorus pentasulfide, 4.0 mL of CS₂, and 8.0 ml of CH₂Cl₂ was refluxed under N₂ for 2 h and then rotary evaporated. A solution of the residue in 20 mL of CH₂Cl₂ was washed with 3 mL of water, dried, and rotary evaporated to give 0.20 g (79%) of 58a as a light yellow oil: ¹H NMR (400 MHz, CD₂Cl₂) δ 3.87 (q, 4H, 2 CH₂O), 3.25 (m, 16H, 2 (CH₃CH₂CH₂)₃N⁺CH₂), 1.71 (m, 20H, 2 (CH₃CH2CH₂)₃N⁺CH₂CH₂, 2 CH₂CH₂O), 1.33 (m, 24H, 2 NCH₂CH₂(CH₂)₆), 1.04 (t, 18H, 6 CH₃); ¹³C NMR (100.6 MHz, CD₂Cl₂) δ 65.23, 61.24, 59.99, 29.11, 29.06, 28.93, 28.75, 26.70, 25.97, 22.60, 16.37, 11.18; ³¹P NMR (162.1 MHz, CD₂Cl₂) δ 114.66; IR (NaCl) 3322 (br), 2928 (vs), 1657 (m), 1473 (vs), 1387 (s), 1273 (m), 964 (s), 851 (m), 799 (m), 730 (s), 681 (vs), 632 (m) cm⁻¹. Anal. Calcd for C₃₈H₈₂N₂O₂PS₂Br.1.5H₂O: C, 56.97; H, 10.69. Found: C, 56.84; H, 10.54. ES MS (methanol) calcd for C₃₈H₈₂N₂O₂PS₂ (surfactant cation) 693.6, found 693.5.

O,O′-Di- [10-(N,N,N-tributylammonio)decyl] phosphorodithioate Bromide (58b). The same general procedure used for surfactant compound 58a, as described above, was repeated, starting with a reaction mixture of 1.52 g (3.6 mmol) of surfactant 61b, 0.200 g (0.45 mmol) of phosphorus pentasulfide, 10.0 mL of CS₂, and 20.0 mL of CH₂Cl₂, which gave 1.10 g (71%) of 58b as a yellow oil: ¹H NMR (CD₂Cl₂) δ 3.87 (q, 4H, 2 CH₂O), 3.27 (m, 16H, 2 (CH₃CH₂CH₂CH₂)₃N⁺CH₂), 1.64 (m, 20H, 2 (CH₃CH₂CH₂CH₂)₃N⁺CH₂CH₂, 2 CH₂CH₂O), 1.41 (m, 36H, 2 (CH₃CH₂CH₂CH₂)₃N⁺CH₂CH₂ (CH₂)₆), 1.01 (t, 18H, 6 CH₃); ¹³C NMR (100.6 MHz, CD₂Cl₂) δ 65.28, 59.93, 59.60, 30.78, 29.18, 29.03, 28.90, 26.76, 26.07, 24.70, 23.52, 22.70, 20.37, 14.04; ³¹P NMR (162.1 MHz, CD₂Cl₂) δ 115.53; IR (NaCl) 2932 (vs), 2856 (vs), 1741 (vs), 1338 (vs), 1172 (m), 1109 (m), 1031 (s), 1003 (s), 883 (s), 830 (s), (s), 738 (s), 682 (vs), 667 (s), 617 (m) cm⁻¹. Anal. Calcd for C₄₄H₉₄N₂O₂PS₂Br.2H₂O: C, 59.10; H, 11.05. Found: C, 59.15; H, 10.80. ES MS (methanol) calcd for C₄₄H₉₄N₂O₂PS2 (surfactant cation) 777.6, found 777.6.

### REFERENCES

1 Myers, D. Surfactant Science and Technology; VCH Publishers: New York, 1992.
2 Knight, C. G. Liposomes: From Physical Structure to Therapeutic Applications; Elsevier/North-Holland: New York, 1981.
3 Novel Surfactants; Holmberg, K., Ed.; Marcel Dekker: New York, 1998.
4 For examples, see (a) Jaeger, D. A. Supramol. Chem. 1995, 5, 27-30, “Cleavable Surfactants”. (b) Holmberg, K. Curr. Opin. Colloid Interface Sci. 1996, 1, 572-579, “Surfactants with Controlled Half-Lives”. (c) Jong, L. I.; Abbott, N. L. Langmuir 2000, 16, 5533-5561, “A Chemodegradable Surfactant System Based on Oxidation of Disulfide Bonds Using Hypochlorite”.
5 Holmberg, K. In Ref. 3; Chapter 11.
6 For reviews, see (a) Menger, F. M.; Keiper, J. S. Angew. Chem., Int. Ed. 2000, 39, 1906-1920, “Gemini Surfactants”. (b) Rosen, M. J.; Tracy, D. J. J. Surfactants Deterg. 1998, 1, 547-554, “Gemini Surfactants”. (c) Zana, R. Curr. Opinion Colloid Interface Sci. 1996, 1, 566-571, “Gemini (Dimeric) Surfactants”.
7 For a partial listing of applications, see Menger, F. M.; Mbadugha, B. J. Am. Chem. Soc. 2001, 123, 875-885, “Gemini Surfactants with a Disaccharide Spacer”.
8 Menger, F. M.; Mounier, C. E. J. Am. Chem. Soc. 1993, 115, 12222-12223, “A Micelle That Is Insensitive to Its Ionization State. Relevance to the Micelle Wetness Problem”.
9 Esumi, K.; Goino, M.; Koide, T. J. Colloid Interface Sci. 1996, 183, 539-545, “Adsorption and Adsolubilization by Monomeric, Dimeric, or Trimeric Quaternary Ammonium Surfactant at Silica/Water Interface”.
10 Masuyama, A.; Yokota, M.; Zhu, Y. -P.; Kida, T.; Nakatsuji, Y. J. Chem. Soc., Chem. Commun. 1994, 1435-1436, “Unique Interfacial Properties of a Homologous Series of Novel Triple-Chain Amphiphiles Bearing Three Anionic Head Groups Derived from 1,1,1-Tris(hydroxymethyl)ethane”.
11 Menger, F. M.; Wrenn, S. J. Phys. Chem. 1974, 78, 1387-1390, “Interfacial and Micellar Properties of Bolaform Electrolytes”.
12 Menger, F. M.; Yamasaki, Y. J. Am. Chem. Soc. 1993, 115, 3840-3841, “Hyperextended Amphiphiles. Bilayer Formation from Single-Tailed Compounds,”.
13 Soldi, V.; Erismann, N. D. M.; Quina, F. H. J. Am. Chem. Soc. 1988, 110, 5137-5143, “Micelle-Mimetic Ionene Polyelectrolytes”.
14 Ogston, A. G.; Holiday, E. R.; Philpot, J. St. L.; Stocken, L. A. Trans. Faraday Soc. 1948, 44, 45-52, “The Replacement Reactions of β,β′-Dichlordiethyl Sulphide and of Some Analogues in Aqueous Solution: The Isolation of β-Chloro-β′-Hydroxy Diethyl Sulfide”.
15 Davey, T. W.; Hayman, A. R. Aust. J. Chem. 1998, 51, 581-586, “Synthesis of ω-Hydroxy Quaternary Ammonium Bolaform Surfactants”.
16 Jaeger, D. A.; Schilling, C. L., III; Zelenin, A. K.; Li, B.; Kubicz-Loring, E. Langmuir 1999, 15, 7180-7185, “Reaction of a Vesicular Functionalized Surfactant with 2-Chloroethyl Phenyl Sulfide, a Mustard Simulant”.
17 Kabachnik, M. I.; Mastryukova, T. A.; Shipov, A. E.; Melent'eva, T. A. Tetrahedron 1960, 9, 10-28, “Application of the Hammett Equation to Theory of Tautomeric Equilibrium. Thione-Thiol Equilibrium, Acidity, and Structure of Phosphorus Thioacids”.
18 March, J. Advanced Organic Chemistry, 4th ed.; Wiley-Interscience: New York, 1992; p 339.
19 Jaeger, D. A.; Zeng, X., unpublished results.
20 Jones, B. A.; Bradshaw, J. S. Chem. Rev. 1984, 84, 17-30, “Synthesis and Reduction of Thiocarboxylic O-Esters”.
21 (a) Allcock, H. R.; O'Connor, S. J. M.; Olmeijer, D. L.; Napierala, M. E.; Cameron, C. G. Macromolecules 1996, 29, 7544-7552, “Polyphosphazenes Bearing Branched and Linear Oligoethyleneoxy Side Groups as Solid Solvents for Ionic Conduction”. (b) Campbell, C.; Viras, K.; Masters, A. J.; Craven, J. R.; Hao, Z.; Yeates, S. G.; Booth, C. J. Phys. Chem. 1991, 95, 4647-4651, “Low-Frequency Raman-Active Modes in Methyl,ω-hydroxyoligo(oxyethyl-ene)s”.
22 Cote, G.; Bauer, D. Anal. Chem. 1984, 56, 2153-2157, “Hydrolysis of the O,O-Dialkyl Phosphorodithioic Acids Used as Extractants in Liquid-Liquid Systems”.
23 Chana, S. S.; Hider, R. C. Tetrahedron Lett. 1994, 35, 9455-9458, “A Novel Macrobicyclic Cryptand Incorporating 3 Endocyclic Hydroxamate Donor Groups”.
24 (a) Jones, M. M.; Burka, L. T.; Hunter, M. E.; Basinger, M.; Campo, G.; Weaver, A. D. J. Inorg. Nulc. Chem. 1980, 42, 775-778, “Dithiocarbamate Chelating Agents for Toxic Heavy Metals”. (b) Shinobu, L. A.; Jones, S. G.; Jones, M. M. Acta Pharmacol. et Toxicol. 1984, 54, 189-194, “Sodium N-Methyl-D-Glucamine Dithiocarbamate and Cadmium Intoxication”.
25 Jaeger, D. A.; Ono, D., Li, B., unpublished results.
26 Masuyama, A.; Akiyama, K.; Okahara, M. J. Am. Oil Chem. Soc. 1987, 64, 764-768, “Surface Active Hydroxamic Acids. I. Preparation and Properties of Long-Chain Alkyl[oligo(oxyethylene)]oxymethylene-hydroxamic acids”.
27 Bode, H. Z. Anal. Chem. 1954, 142, 414-423, “Systematic Study of the Use of Diethyldithiocarbamate (DDTC) in Analysis. I. Stability of the Sodium Salt and Its Extractability versus the pH of the Solution” (Chem. Abstr. 1954, 48, 13522h).
28 Martin, A. E. Anal. Chem. 1953, 25, 1260-1261, “Instability of Diethyldithiocarbamic Acid at Low pH”.
29 Hallaway, M. Biochim. Biophys. Acta 1959, 36, 538-540, “The Stability of Sodium Diethyldithiocarbamate in Biochemical Experiments”.
30 Thorn, G. D.; Ludwig, R. A. The Dithiocarbamates and Related Compounds; Elsevier: New York, 1962; (a) Chapter 3; (b) Chapter 4; (c) Chapter 6.
31 (a) Hudson, H. R.; Pianka, M.; Powroznik, L.; Lynch, V. P. J. Labelled Compd. Radiopharm. 1980, 17, 383-387, “Preparation of 14C-Labeled Guazatine (1,17-bis-[14C]Guanidino-9-azaheptadecane Triacetate)”. (b) Lee, Y. B.; Park, M. H.; Folk, J. E. J. Med. Chem. 1995, 38, 3053-3061, “Diamine and Triamine Analogs and Derivatives as Inhibitors of Deoxyhypusine Synthase: Synthesis and Biological Activity”. (c) Koumoto, Y.; Hisamoto, Y.; Shinoda, S.; Yamamoto, S. Chem. Pharm. Bull. 1990, 38, 1648-1652, “Effects of Various Triamines on Cell-Free Polypeptide Synthesis of Escherichia Coli and On Growth of Its Polyamine Auxotrophs”.
32 (a) Fendler, J. H. Membrane Mimetic Chemistry; Wiley-Interscience: New York, 1982. (b) Fendler, J. H.; Fendler, E. J. Catalysis in Micellar and Macromolecular Systems; Academic Press: New York, 1975.
33 Browning, J. L. In Ref. 2; Chapter 7.
34 Lewis, K. A.; Soltys, C. E.; Yu, K.; Roberts, M. F. Biochemistry 1994, 33, 5000-5010, “Micellar Bolaform and β-Carboxylate Phosphatidylcholines as Substrates for Phospholipases”.
35 For reviews, see (a) Menger, F. M.; Angelova, M. I. Acc. Chem. Res. 1998, 31, 789-797, “Giant Vesicles: Imitating the Cytological Processes of Cell Membranes”. (b) Menger, F. M.; Keiper, J. S. Curr. Opin. Chem. Biol. 1998, 2, 726-732, “Chemistry and Physics of Giant Vesicles as Biomembrane Models”.
36 McElhaney, R. N. Chem. Phys. Lipids 1982, 30, 229-259, “The Use of Differential Scanning Calorimetry and Differential Thermal Analysis in Studies of Model and Biological Membranes”.
37 Menger, F. M.; Caran, K. L.; Apkarian, R. P. Langmuir 2000, 16, 98-101, “In-Lens Cryo-High-Resolution Scanning Electron Microscopy of Large Vesicles”.
38 For an example, see Peresypkin, A. V.; Menger, F. M. Org. Lett. 1999, 1, 1347-1350, “Zwitterionic Geminis. Coacervate Formation from a Single Organic Compound”.
39 (a) Yang, Y.-C.; Baker, J. A.; Ward, J. R. Chem. Rev. 1992, 92, 1729-1743, “Decontamination of Chemical Warfare Agents”. (b) Yang, Y.-C. Chem. Ind. (London) 1995, 334-337, “Chemical Reactions for Neutralising Chemical Warfare Agents”. (c) Yang, Y.-C. Acc. Chem. Res. 1999, 32, 109-115, “Chemical Detoxification of Nerve Agents”.
40 Jaeger, D. A.; Zelenin, A. K. Langmuir 2000, 16, 9677-9679, “Reactions of a Vesicular Functionalized Surfactant with Alkyl 2-Chloroethyl Sulfides (Mustard Simulants),”.
41 (a) Yang, Y.-C.; Ward, J. R.; Luteran, T. J. Org. Chem. 1986, 51, 2756-2579, “Hydrolysis of Mustard Derivatives in Aqueous Acetone-Water and Ethanol-Water Mixtures”. (b) McManus, S. P.; Karaman, R. M.; Sedaghat-Herati, R.; Hovanes, B. A.; Ding, X.-T.; Harris, J. M. J. Org. Chem. 1993, 58, 6466-6469, “Synthesis, Isolation, and Reactivity of a Deuterated Mustard Simulant: 2-(Phenylthio)ethyl-2,2-d2 Chloride”. (c) McManus, S. P.; Neamati-Mazaeh, N.; Hovanes, B. A.; Paley, M. S.; Harris, J. M. J. Am. Chem. Soc. 1985, 107, 3393-3395, “Hydrolysis of Mustard Derivatives. Failure of the Raber-Harris Probe in Predicting Nucleophilic Assistance”. (d) Bartlett, P. D.; Swain, C. G. J. Am. Chem. Soc. 1949, 71, 1406-1415, “Kinetics of Hydrolysis and Displacement Reactions of β,β′-Dichlorodiethyl Sulfide (Mustard Gas) and of β-Chloro-β′-hydroxydiethyl Sulfide (Mustard Chlorohydrin). (e) Bordwell, F. G.; Brannen, W. T., Jr. J. Am. Chem. Soc. 1964, 86, 4645-4650, “The Effect of the Carbonyl and Related Groups on the Reactivity of Halides in SN2 Reactions”.
42 Yang, Y.-C.; Szafraniec, L. L.; Beaudry, W. T.; Ward, J. R. J. Org. Chem. 1988, 53, 3293-3297, “Kinetics and Mechanism of the Hydrolysis of 2-Chloroethyl Sulfides”.
43 For examples, see (a) Wagner, G. W.; Yang, Y.-C. Ind. Eng. Chem. Res. 2002 41,1925-1928, “Rapid Nucleophilic/Oxidative Decontamination of Chemical Warfare Agents”. (b) Wagner, G. W.; Procell, L. W.; Yang, Y.-C.; Bunton, C. A. Langmuir 2001, 17, 4809-4811, Molybdate/Peroxide Oxidation of Mustard in Microemulsions”. (c) Menger, F. M.; Rourk, M. J. Langmuir 1999, 15, 309-313, “Deactivation of Mustard and Nerve Agent Models via Low-Temperature Microemusions”. (d) Menger, F. M.; Elrington, A. R. J. Am. Chem. Soc. 1991, 113, 9621-9627, “Organic Reactivity in Microemulsion Systems”. (e) Bacaloglu, R.; Blasko, A.; Bunton, C. A.; Foroudian, H. J. J. Phys. Org. Chem. 1992, 5, 171-178, “Micellar Effects upon the Oxidation of Organic Sulfides by Anionic Reagents”. (f) Aubry, J.-M.; Bouttemy, S. J. Am. Chem. Soc. 1997, 119, 5286-5284, “Preparative Oxidation of Organic Compounds in Microemulsions with Singlet Oxygen Generated by the Sodium Molybdate/Hydrogen Peroxide System”. (g) Boring, E; Geletii, Y.; Hill, C. L. J. Mol. Catal. A—Chem. 2001, 176, 49-63, “Catalytic Aerobic Oxidation of 2-Chloroethyl Ethylsulfide, a Mustard Simulant, Under Ambient Conditions—Effect of Solvents, Ligands, and Transition Metals on Reactivity”.
44 Yang, Y.-C.; Szafraniec, L. L.; Beaudry, W. T.; Davis, F. A. J. Org. Chem. 1990, 55, 3664-3666, “A Comparison of the Oxidative Reactivities of Mustard (2,2′-Dichlordiethyl Sulfide) and Bivalent Sulfides”.
45 For examples, see (a) Sumida, Y.; Masuyama, A.; Takasu, M.; Kida, Y.; Nakatsuji, Y.; Ikeda, I.; Nojima, M. Langmuir 2001, 17, 609-612, “New pH-Sensitive Vesicles. Release Control of Trapped Materials from the Inner Aqueous Phase of Vesicles Made from Triple-Chain Amphiphiles Bearing Two Carboxylate Groups”. (b) Frankel, D. A.; Lamparski, H.; Liman, U.; O'Brien, D. F. J. Am. Chem. Soc. 1989, 111, 9262-9263, “Photoinduced Destabilization of Bilayer Vesicles”. (c) Gregoriadis, G., Ed. Liposomes as Drug Carriers: Recent Trends and Progress; Wiley: New York, 1988.
46 Weinstein, J. N. Pure Appl. Chem. 1981, 53, 2241-2254, “Liposomes as ‘Targeted’ Drug Carriers: a Physical Chemical Perspective”.
47 For example, see Moss, R. A.; Jiang, W. Langmuir 1997, 13, 4498-4501, “Thermal Modulation of Photoisomerization in Double-Azobenzene-Chain Liposomes”, and references therein.
48 For an overview of chemical triggering, a related application, see Sabongi, G. J. Chemical Triggering; Plenum: New York, 1987.
49 Ramadas, K.; Srinivasan, N. Synth. Commun. 1995, 25, 227-234, “Sodium Chlorite—Yet Another Oxidant for Thiols to Disulfides”.
50 Capozzi, G; Modena, G. In The Chemistry of the Thiol Group; Part 2; Patai, S., Ed.; Wiley: New York, 1974; Chapter 17.
51 Wardell, J. L. In The Chemistry of the Thiol Group; Part 1; Patai, S., Ed.; Wiley: New York, 1974; Chapter 4.
52 Hovinen, J.; Guzaev, A.; Azhayev, A.; Lrnnberg, H. Tetrahedron Lett. 1993, 34, 8169-8172, “Synthesis of 3′-Functionalized Oligonucleotides On a Single Solid Support”
53 For examples and an overview, see (a) Scamehorn, J. F.; Christian, S. D.; Ellington, R. T. In Surfactant-Based Separation Processes; Scamehorn, J. F.; Harwell, J. H., Eds.; Surfactant Science Series, Vol. 33; Marcell Dekker: New York, 1989; pp 29-51. (b) Scamehorn, J. F.; Harwell, J. H. In Surfactant-Based Separations -Science and Technology; Scamehorn, J. F.; Harwell, J. H., Eds.; ACS Symposium Series 740; American Chemical Society: Washington, D.C., 2000; pp 1-14, and references therein.
54 For examples and an overview, see (a) Simmons, D. L.; Schovanec, A. L.; Scamehorn, J. F.; Christian, S. D.; Taylor, R W. In Environmental Remediation; Vandegrift, G. F.; Reed, D. T.; Tasker, I. R., Eds.; ACS Symposium Series 509; American Chemical Society: Washington, D.C., 1992; pp 180-193. (b) Tondre, C. In Ref. 45b; pp 139-157.
56 Klepac, J.; Simmons, D. L.; Taylor, R. W.; Scamehorn, J. F.; Christian, S. D. Sep. Sci. Technol. 1991, 26, 165-173, “Use of Ligand-Modified Micellar-Enhanced Ultrafiltration in the Selective Removal of Metal Ions From Water”.
56 (a) Sabot, J. L.; Bauer, D. J. Inorg. Nucl. Chem. 1978, 40, 1129-1134, “Liquid-Liquid Extraction of Nickel (II) by Dialkylphosphorodithioic Acids”. (b) Levin, I. S.; Sergeeva, V. V.; Tarasova, V. A.; Varentsova, V. I.; Rodina, T. F.; Vorsina, I. A.; Kozlova, N. E.; Kogan, B. I. Russ. J. Inorg. Chem. 1973, 18, 867, “Extraction of Metals by Alkyldithiophosphoric Acids”.
57 Sakulwongyai, S.; Trakultamupatam, P.; Scamehorn, J. F.; Osuwan, S.; Christian, S. D. Langmuir 2000, 16, 8226-8230, “Use of a Surfactant Coacervate Phase to Extract Chlorinated Aliphatic Com-pounds from Water: Extraction of Chlorinated Ethanes and Quantitative Comparison to Solubilization in Micelles”. Also see Gullickson, N. D.; Scamehorn, J. F.; Harwell, J. H. In Ref. 45a; pp 139-152.
58 Kang, S.-K.; Kim, W.-S.; Moon, B.-H. Synthesis 1985, 1161.
59 Davey, T. W.; Haymen, A. R. Aust. J. Chem. 1998, 51, 581.

A number of literature references are cited in the foregoing application in order to more fully describe the state of the art to which this invention pertains. The entire disclosure of each of these citations is incorporated by reference herein.

While certain embodiments of the present invention have been described and/or specifically exemplified above, various other embodiments will be apparent to those skilled in the art from the foregoing disclosure. The present invention is, therefore, not limited to such embodiments, but is capable of considerable variation and modification without departing from the scope of the following claims.

What is claimed is:

1. A surfactant compound of the formula: [X-L-Z-L′-X′] (A)ₚ,
wherein X and X′ represent outer head groups, which may be the same or different and comprise charged moieties selected from the group of —N⁺R¹R²R³, R¹, R² and R³ being the same or different and representing hydrocarbyl groups, —CO₂⁻ or —O(CH₂)ₘSO₃⁻, m being an integer from 2 to 30, or polar moieties of the formula, —O—(CH₂CH₂O)ₙ—R⁴, R⁴ being hydrogen or a C₁-C₆ hydrocarbyl group and n is an integer from 1 to 1000; L and L′ are the same or different and represent a hydrocarbon linking moiety which may optionally be interrupted with oxygen; Z represents a central head group selected from a dithiophosphate moiety, 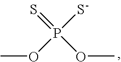
a dithiocarbamate moiety, 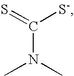
or a quaternary ammonium moiety, 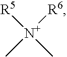
wherein R⁵ and R⁶ are the same or different and represent C₁-C₆ hydrocarbyl groups, with the proviso that when Z represents said dithiocarbamate moiety or said quaternary ammonium moiety, X and X′ do not represent NR¹R²R³, and with the further proviso that X and X′ do not represent —O(CH₂)ₘSO₃⁻ unless Z represents said quaternary ammonium moiety; and A represents a counter ion, which may be either positive or negative depending on the net charge of [X-L-Z-L′-X′] and p is an integer which, when multiplied by the valency of said counter ion yields the absolute value of the net charge of [X-L-Z-L′-X′].

2. The surfactant of claim 1, wherein said central head group Z represents said dithiophosphate moiety, said linking moieties L and L′ are the same and represent a straight or branched chain hydrocarbyl group having 6 to 30 carbon atoms and said outer head groups X and X′ are the same and represent —NR¹R²R³, —CO₂⁻ or —O—(CH₂CH₂O)ₙR⁴, R¹, R² and R³ being the same or different and representing hydrocarbyl groups, R⁴ being a hydrogen or a C₁-C6 hydrocarbyl group and n is an integer from 1 to 1000.

3. The surfactant of claim 2, wherein R¹, R² and R³ represent propyl or butyl groups.

4. The surfactant of claim 2 having the formula:

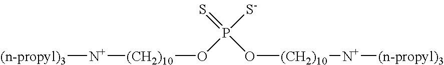

5. The surfactant of claim 2 having the formula:

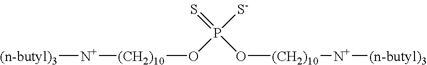

6. The surfactant of claim 1 wherein said central head group Z represents said dithiocarbamate moiety, said linking moieties L and L′ are the same and represent a straight or branched chain hydrocarbyl group having 6 to 30 carbon atoms or a straight or branched chain hydrocarbyl group having 6 to 30 carbon atoms which is interrupted with oxygen, and said outer head groups X and X′ are the same and represent —CO₂⁻ or —O—(CH₂CH₂O)ₙR⁴, R⁴ being a hydrocarbyl group and n is an integer from 1 to 1000.

7. The surfactant compound of claim 1 wherein said central head group Z represents said quaternary ammonium moiety, said linking moieties L and L′ are the same and represent a straight or branched chain hydorcarbyl group having 6 to 30 carbon atoms and said outer head groups X and X′ are the same and represent —O—(CH₂)₃SO₃⁻ or —O(CH₂CH₂O)ₙCH₃, n being an integer from 1 to 1000.

8. A process for the chemical decontamination of mustard (i.e. ClCH₂CH₂SCH₂CH₂Cl), said process comprising reacting said mustard with aggregates of at least one surfactant compound-of claim 1, wherein said central head group is a dithiophosphate moiety or a dithiocarbamate moiety, under conditions causing a residue of said mustard to be chemically bound to said surfactant compound, thereby decontaminating said mustard.

9. The method of claim 8, wherein said reaction is conducted in an aqueous medium and after the occurrence of said reaction the aggregates of said at least one surfactant compound are separated from said aqueous medium.

10. The method of claim 9, wherein said separation is effected by filtration.

11. A method for controlling release of a material contained within an aggregated surfactant, said method comprising:
a. providing an aggregated surfactant composed of at least one surfactant compound, as claimed in claim 1, wherein said central head group is a dithiophosphate moiety or a dithiocarbamate moiety, said material being in the aggregated sufactant; and
b. oxidizing said aggregated surfactant, thereby forming a disulfide-linked dimer from said surfactant compounds and releasing said material from said aggregated surfactant.

12. The method of claim 11, wherein said aggregated surfactant is composed of at least one surfactant compound wherein said central head group Z represents said dithiophosphate moiety, said linking moieties L and L′ are the same and represent a straight or branched chain hydrocarbyl group having 6 to 30 carbon atoms and said outer head groups X and X′ are the same and represent —NR¹R²R³, —CO₂⁻ or —O—(CH₂CH₂O)ₙR⁴, R¹, R² and R³ being the same or different and representing hydrocarbyl groups, R⁴ being a hydrogen or a C₁-C₆ hydrocarbyl group and n is an integer from 1 to 1000.

13. The method of claim 11, wherein said aggregated surfactant is composed of a surfactant compound wherein said central head group Z represents said dithiocarbamate moiety, said linking moieties L and L′ are the same and represent a straight or branched chain hydrocarbyl group having 6 to 30 carbon atoms or a straight or branched chain hydrocarbyl group having 6 to 30 carbon atoms which is interrupted with oxygen and said outer head groups X and X′ are the same and represent —CO₂⁻ or —O—(CH₂CH₂O)ₙR⁴, R⁴ being a hydrogen or a C₁-C₆ hydrocarbyl group and n is an integer from 1 to 1000.

14. A process for removing heavy metal ions from a liquid medium containing said ions, said process comprising adding to said liquid medium a surfactant compound of the formula:
[X-L-Z-L′-X′] (A)ₚ,
wherein X and X′ represent outer head groups, which may be the same or different and comprise charged moieties selected from the group of —N⁺R¹R²R³, R¹, R² and R³ being the same or different and representing hydrocarbyl groups, —CO₂⁻ or —O(CH₂)ₘSO₃⁻, m being an integer from 2 to 30, or polar moieties of the formula —O—(CH₂CH₂O)ₙ—R⁴, R⁴ being hydrogen or a C₁-C₆ alkyl group and n is an integer from 1 to 1000; L and L′ are the same or different and represent a hydrocarbon linking moiety which may optionally be interrupted with oxygen and Z represents a central head group selected from a dithiophosphate moiety, 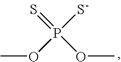
a dithiocarbamate moiety, 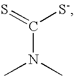
or a quaternary ammonium moiety, 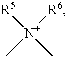
wherein R⁵ and R⁶ are the same or different and represent C₁-C₆ hydrocarbyl groups, with the proviso that when Z represents said dithiocarbamate moiety, X and X′ do not represent NR¹R²R³, and with the further proviso that X and X′ do not represent —O(CH₂)SO₃⁻ unless Z represents said quaternary ammonium moiety; and A represents a counter ion, which may be either positive or negative depending on the net charge of [X-L-Z-L′-X′] and p is an integer which, when multiplied by the valency of said counter ion yields the absolute value of the net charge of [X-L-Z-L′-X′], said surfactant compound being added to said liquid medium in an amount effective to form aggregates comprising said surfactant compound complexed with said heavy metal ions; and filtering said liquid medium to separate said aggregates from said liquid medium.

15. The process of claim 14, including the further step of oxidizing said aggregates in a reaction medium to release said heavy metal ions and form aggregates comprising dimers of said surfactant compounds linked by a disulfide bond between their central head groups; separating the dimer-containing aggregate from said reaction medium; regenerating said surfactant compound from said dimers; and recycling said surfactant compounds to said process.

16. The process of claim 15, wherein said surfactant compound is regenerated from said dimer by reacting said dimer with a reducing agent.
